(19) United States
(12) Patent Application Publication
(10) Pub. No.: US 2025/0329313 A1
(43) Pub. Date: Oct. 23, 2025

(54) PLECTRUM FOR MUSICAL INSTRUMENTS

(71) Applicant: Andrea ZECCHIN, Volpago del Montello (TV) (IT)

(72) Inventor: Andrea ZECCHIN, Volpago del Montello (TV) (IT)

(21) Appl. No.: 18/640,258

(22) Filed: Apr. 19, 2024

(51) Int. Cl. G10D 3/173

(52) U.S. Cl. CPC G10D 3/173

(57) ABSTRACT

An accessory for stringed musical instruments such as a plectrum includes special extensions that allows it to be stored between the strings of the musical instrument and which, at the same time, allows the user to play the instrument also with their fingers, i.e. without the plectrum, while at the same time leaving the plectrum connected to the strings of the instrument so that it is not lost or damaged by falling

### FIELD OF THE INVENTION

The invention is for use in the field of musical instruments and related accessories, in particular in the field of stringed musical instruments and, more particularly, in the field of plectrums.

### BACKGROUND

A plectrum is a small device used since antiquity, for example, by the ancient Greeks to set in vibration the strings of certain musical instruments (10), such as, for example, in ancient times, the lyre or the zither.

Nowadays, the plectrum is a small, typically triangular-shaped blade of various materials used to play stringed musical instruments (10) by vibrating their strings, such as a mandolin, guitar and other similar instruments.

In the case of the guitar, the plectrum is used to make strokes applied to the strings of the guitar, which when touched forcefully or softly, vibrate and emit a sound or note.

Typically, the plectrum known today consists of a triangular-shaped blade with beveled vertices, which can be made of different materials that impart hardness or plasticity. Some of the plectrums commonly available on the market are made of: bone, hard woods, celluloid, or various types of plastic material.

Usually, the plectrum is in the shape of an isosceles triangle with rounded corners; the sharpest angle is the one commonly used for plucking the strings. In some, rarer cases, the plectrum is circular in shape. FIG. 5 shows an example of a standard plectrum, placed between the strings of a guitar.

The plectrum is gripped between the thumb and forefinger of the playing hand.

The plectrum can have various thicknesses in the range of millimeters depending on the material it is made of and its hardness, thus allowing for different timbres.

When the stringed musical instrument (10) is not in use, the plectrum may be stored in a case or other receptacle usually fixed externally on the opposite side of the musical instrument from the side where the strings are and/or from the side where the instrument is played. This opposite side of the musical instrument, e.g. the guitar, is an awkward part to reach, especially when playing. Alternatively, for practicality, the plectrum can be temporarily placed on a player's leg or in a player's mouth, but these solutions are not always functional, because the plectrum can fall on the floor and be damaged or in any case these are unhygienic situations. Another way, sees the plectrum attached to the strings and held between them as illustrated in FIG. 5. The disadvantage of this method of storing the plectrum lies in the fact that in order to play the instrument, it is necessary to move the plectrum and put it somewhere else, with the real risk of losing it or dropping it. In other words, the plectrum known today can be placed between the strings of the instrument but this does not allow the instrument to be played, e.g. with the hands alone, without it being removed and thus being easily lost or damaged by falling. All the above-mentioned solutions are therefore impractical solutions for the above-mentioned reasons.

Finally, the familiar types of picks are often awkward to grip and/or slip from the hands.

### SUMMARY

The present invention relates to a plectrum for playing stringed musical instruments (10).

The problem addressed by the present invention is thus to provide a plectrum which allows it to be stored between the strings of the musical instrument and which, at the same time, allows the user to play the instrument also with their fingers, i.e. without the plectrum, while at the same time leaving the plectrum connected to the strings of the instrument so that it is not lost or damaged by falling.

Such a problem is solved by the plectrum according to the present invention, by the method for storing the plectrum, as outlined in the appended claims, the definitions of which are an integral part of the present description.

Further features and advantages of the plectrum of the invention and of the method for storing it will result from the description of the examples of embodiments of the invention, provided as an embodiment and of the invention.

### BRIEF DESCRIPTION OF THE DRAWINGS

The invention will be described in more detail below with reference to the appended figures of a form of embodiment.

FIG. 1 shows a front perspective view of the plectrum according to a form of embodiment of the invention and just to the side and below are side and top views of the plectrum respectively (1). FIG. 1 shows the two extensions (2), the upper part (4) which allows the plectrum (1) to be gripped and the lower part (3) which is suitable for playing the stringed musical instrument (10), the body of the plectrum (9) and the central portion (8).

FIGS. 2, 3 and 4 show perspective views of the plectrum (1) according to different preferred forms of realization. In particular, in FIG. 2, a plectrum without additional elements is observed. FIG. 3 and FIG. 4 show plectrums according to preferred forms of fabrication in which there is an embossing (5) comprising embossed elements designed to improve the grip of the plectrum and a hole (6) which allows the plectrum to be worn by means of a string passed through this hole, a string which is then tied around the user's neck, in the form of a necklace. FIG. 3 further shows a reinforcing element (7). Said reinforcing element is arranged centrally to the plectrum (1). The embossing (5), in FIGS. 3 and 4, comprises embossed elements (5) which have a round or rounded profile.

FIG. 5 shows a perspective view of a known plectrum, i.e. a standard plectrum, as it is stored today. In this specific case, for example, between the strings of a guitar.

FIG. 6 shows a perspective view of a plectrum of the invention, as housed between the strings of the musical instrument (10), in particular of a guitar, which, evidently, allows the instrument to be played (with fingers) without having to remove said plectrum.

FIGS. 7 to 12 show frontal views of preferred embodiments of the plectrum (1) according to the invention, in which the extensions (2) and the central body (8) are highlighted.

### DETAILED DESCRIPTION OF THE PREFERRED EMBODIMENTS

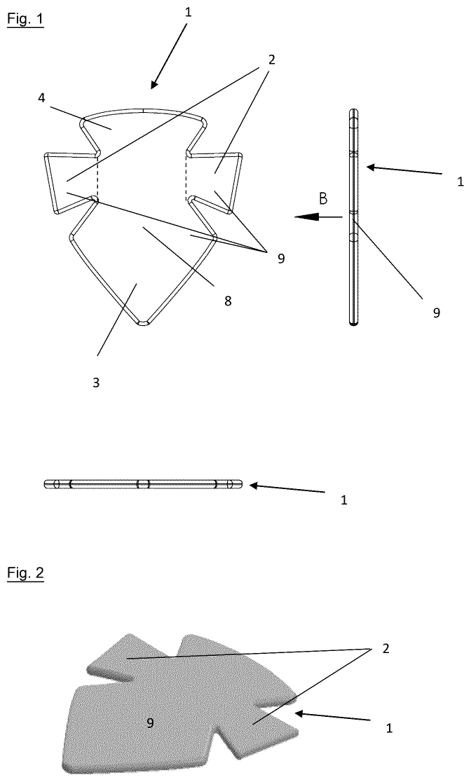

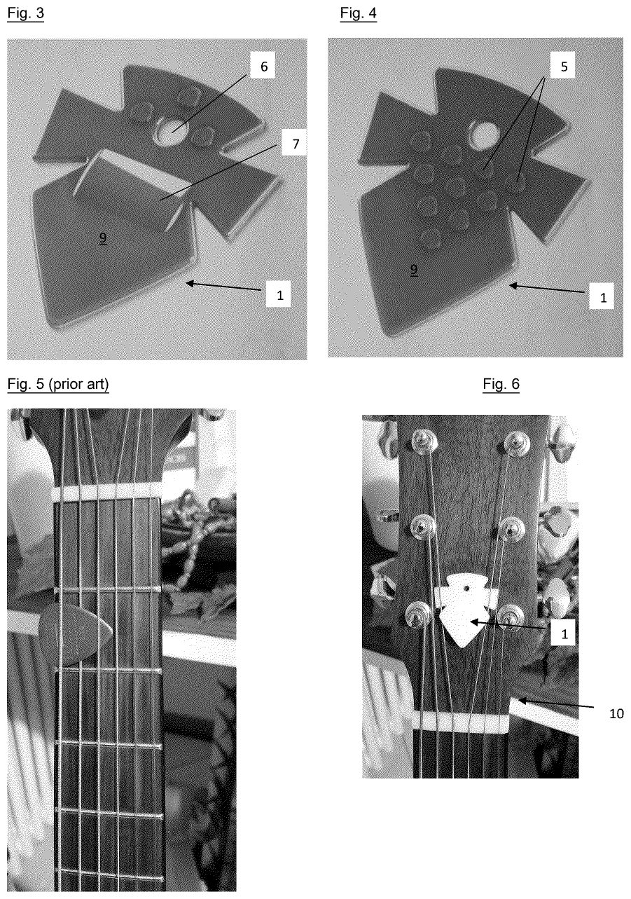

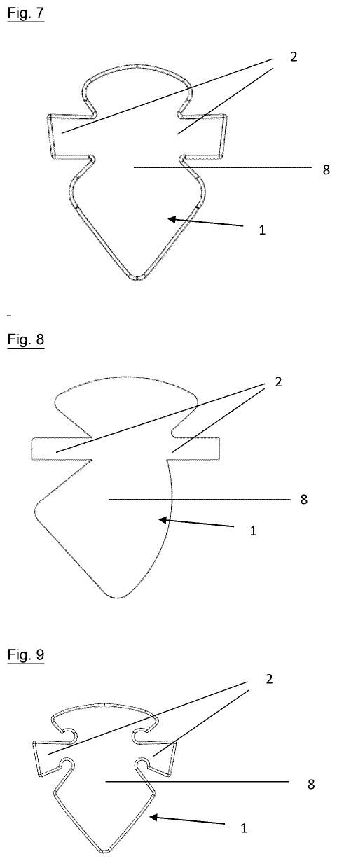

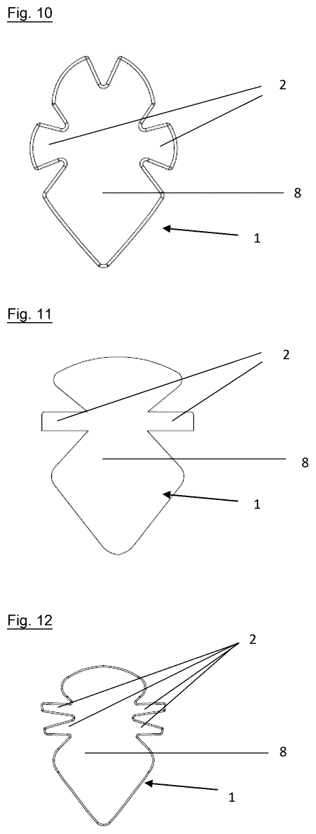

For the purposes of the description herein, the terms “top”, “bottom”, “right”, “left”, “rear”, “front”, “vertical”, “horizontal” and derivatives thereof refer to the oriented concepts of the front perspective view in FIG. 1.

However, it should be understood that the concepts may take various alternative orientations, except where expressly stated otherwise.

As used herein, the term “and/or”, when used in a list of two or more items, means that any one of the listed items may be employed alone, or in any combination of two or more of the listed items.

For example, if a combination of items is described as containing components A, B and/or C, the combination may contain only A; only B; only C; A and B in combination; A and C in combination; B and C in combination; or A, B and C in combination.

The terms “comprises”, “comprising” or any variation thereof are intended to cover a non-exclusive inclusion, such that a pick, method or object comprising a list of elements does not include only those elements but may include other elements not expressly listed or inherent in that pick, method, etc.

An element followed by “includes . . . a . . . ” does not preclude, without further constraint, the existence of further identical elements in the pick, method, etc. comprising the element.

An object of the present invention is a plectrum (1) comprising a flat cruciform body (9).

It has been surprisingly found that said plectrum (1) can be inserted between part of the strings of the musical instrument (10) not suitable to be vibrated, for example, preferably between the strings of a headstock portion of a musical instrument (10), in this case a guitar, as schematically illustrated in FIG. 6.

Said flat cruciform body allows for the insertion, by swiping, of the plectrum between the strings of the musical instrument, for example between the strings of the guitar in the area of the headstock where the keys and the so-called tuning machines are located. The fastening takes place by sliding/swiping the plectrum between the strings, e.g. of the headstock, or between the strings of the guitar's end piece (as in FIG. 6).

The fastening is done by sliding the plectrum between the strings of the headstock where the tip of the plectrum or the lower part (3) is directed towards the pit of the instrument (10), i.e. towards the area of the instrument where the sound is emitted.

In the case where the musical instrument (10) is a guitar, the plectrum (1) makes it easy to play in strumming or arpeggio mode and to alternate very easily between arpeggios by hand (“finger style” technique) and arpeggios using a plectrum (“picking style”).

According to one embodiment, the plectrum (1) comprises a body (9) comprising at least two extensions (2) extending laterally with respect to a central portion (8).

The central portion (8) is the central portion of the plectrum; for example, that between the dotted lines of FIG. 1, extending from below to above for the entire height of the plectrum.

The extensions (2) may also be referred to as flaps.

According to one form of construction, the plectrum (1) has at least two extensions (2) and at the point of contact between the extensions (2) and the central portion (8) there are angled notches. The latter come into contact with the round profile of the metal strings of the instrument and improve its anchorage.

According to one embodiment, the plectrum (1) has at least two extensions (2) which are symmetrical with respect to the central portion (8).

According to a form of embodiment, the extensions (2) of the plectrum (1) are two or four arranged symmetrically with respect to the central portion (8).

According to a form of embodiment, wherein the body (9) comprises at least two extensions (2) extending laterally with respect to a central portion (8) and the extensions (2) are two or four arranged symmetrically with respect to the central portion (8).

According to a form of embodiment, the at least two extensions (2) of the plectrum (1) have a width less than the width of the central portion (8).

According to a form of embodiment, the at least two extensions (2) of the plectrum (1) have a rectangular shape and one of the two shorter sides is fixed on the central portion (8).

According to a form of embodiment, said central portion (8) of the plectrum (1) has an acute-shaped end configured to pluck a string of a stringed instrument (10).

According to a preferred embodiment, said central portion (8) of the plectrum (1) comprises a surface embossing (5).

According to a preferred embodiment, the plectrum (1) has on the surface of the upper and/or central portion a surface embossing (5) wherein said surface embossing comprises one or more raised elements. Said elements are intended to exert a non-slip “grip” function on the fingertips. Moreover, said embossed elements are in fact useful elements for obtaining a greater grip effect on the fingertips of the hand.

According to a more preferred embodiment, the surface embossing (5) comprises embossed elements having a round or rounded profile.

According to a preferred embodiment, the central portion (8) of the plectrum (1) comprises a reinforcing element (7).

According to a form of embodiment, the body (9) of the plectrum (1) comprises a hole (6).

Indeed, according to a preferred embodiment, the body (9) of the plectrum (1) has a hole (6) on its upper side. Said hole (6) is suitable so that the plectrum (1) can be worn, for example, by means of a string passing through it, like a necklace. Thus, the plectrum (1) may be, for example, hung around the neck, by means of a lanyard.

The plectrum (1) may be made of a plastic material and the thickness may vary from 0.5 mm to 5 mm.

According to one embodiment, the body (9) of the plectrum (1) is made of semi-rigid plastic material.

Another object is a method of storing a plectrum comprising the step of inserting the side extensions (2) of a plectrum (1) comprising a flat body (9) cruciform between the strings of a stringed musical instrument (10).

Another object is a kit comprising the plectrum of the invention and a box or pouch suitable for containing it.

The advantages of the invention are greater ease in storing the plectrum during performance, novel design, innovative grip profile and can be worn as a necklace or bracelet of symbolic value.

The two different sides of the guitar are named: the part where the strings are (the side used for playing) is called the body while the part behind it is called the back (or back). The plectrum fulfils its purpose since the body of the guitar's headstock is easily reached by the right hand during musical performance. By extending the arm and the right hand, the plectrum can easily reach the strings located between the levers and the tuning machines. Later, by sliding it can be fixed due to the friction generated on their surface. The tip of the plectrum, i.e. the same one that touches the strings during the performance, will face the hole of the guitar (see FIG. 6). The plectrum, since it has been fixed if it is to be used again, will have to be pulled out by swiping towards the upper tip of the headstock.

The pick (1) may preferably be hung around the neck by means of a lanyard.

Its cross-shaped design facilitates insertion between the strings of the guitar in the headstock area, attachment is by sliding the pick. The advantages of the invention are found in the easier storage of the pick during performance, the novel design, the innovative non-slip profile and it can be worn as a necklace or bracelet with symbolic value.

Summarizing, as additional advantages, the plectrum of the invention allows one to:
play more easily,
facilitate the transition from one guitar style to another,
have greater ease in storing the pick when playing,
wear the plectrum.
easily attach the plectrum between the strings on the “headstock” of the guitar.

With respect to the foregoing description, therefore, it should be understood that the optimal dimensional relationships for parts of a form of embodiment of the invention, to include variations in size, materials, form, function and mode of operation, assembly and use, are considered readily apparent and obvious to engineers in the art and all relationships equivalent to those illustrated in the drawings and described in the specification are intended to be included in a form of embodiment of the invention.

In order to realize the invention, the person in the industry can very easily prepare a plectrum like the one in the invention.

What is claimed is:

1. A plectrum (1) comprising a cruciform flat body (9).

2. The plectrum (1) according to claim 1, wherein the body (9) comprises at least two extensions (2) protruding laterally with respect to a central portion (8).

3. The plectrum (1) according to claim 2, wherein the extensions (2) are two or four in number arranged symmetrically with respect to the central portion (8).

4. The plectrum (1) according to claim 1, wherein the body (9) comprises at least two extensions (2) protruding laterally with respect to a central portion (8) and the extensions (2) are two or four arranged symmetrically with respect to the central portion (8).

5. The plectrum (1) according to claim 2, wherein the at least two extensions (2) have a width less than a width of the central portion (8).

6. The plectrum (1) according to claim 2, wherein said central portion (8) has an acute-shaped end configured for plucking a string of a stringed instrument (10).

7. The plectrum (1) according to claim 2, wherein said central portion (8) comprises a surface embossing (5).

8. The plectrum (1) according to claim 2, wherein said central portion (8) comprises a reinforcing element (7).

9. The plectrum (1) according to claim 1, wherein said body (9) comprises a hole (6).

10. The plectrum (1) according to claim 1, wherein said body (9) is constituted of semi-rigid plastic material.

11. A method for storing a plectrum comprising the step of inserting the side extensions (2) of a plectrum (1) comprising a cruciform flat body (9) between the strings of a stringed musical instrument (10).

12. A method for storing a plectrum comprising the step of inserting the side extensions (2) of a plectrum (1) comprising a cruciform flat body (9) between the strings of a stringed musical instrument (10), wherein the plectrum (1) is a plectrum according to claim 1.

13. A method for storing a plectrum comprising the step of inserting the side extensions (2) of a plectrum (1) comprising a cruciform flat body (9) between the strings of a stringed musical instrument (10), wherein the plectrum (1) is a plectrum according to claim 2.
